(19) United States
(12) Patent Application Publication
(10) Pub. No.: US 2002/0018246 A1
(43) Pub. Date: Feb. 14, 2002

(54) Image sensing apparatus and method of controlling operation of same

(76) Inventor: Takeshi Misawa, Asaka-shi (JP)

Correspondence Address: BIRCH STEWART KOLASCH & BIRCH, PO BOX 747, FALLS CHURCH, VA, 22040-0747, US

(21) Appl. No.: 09/764,062

(22) Filed: Jan. 19, 2001

(30) Foreign Application Priority Data
Jan. 21, 2000 (JP) 2000-12657

(51) Int. Cl. H04N 1/04

(52) U.S. Cl. 358/474; 358/482

(57) ABSTRACT

Data representing the characteristics of a honeycomb CCD are stored on a ROM. The image of a subject is sensed by the honeycomb CCD and image data representing the image of the subject is recorded on a memory card. The data representing the characteristics of the honeycomb CCD is read out of the ROM and is recorded on the memory card in association with the image data. When an image is reproduced, correction of the image data can be performed comparatively accurately utilizing the characteristics data.

### BACKGROUND OF THE INVENTION

1. Field of the Invention

This invention relates to an image sensing apparatus for sensing the image of a subject using a so-called honeycomb-type solid-state electronic image sensor, and to a method of controlling this apparatus.

2. Description of the Related Art

A conventional solid-state electronic image sensor has a number of photoelectric transducers arrayed systematically in row and column directions. A so-called honeycomb-type solid-state electronic image sensor has been proposed as such a solid-state electronic image sensor.

A honeycomb-type solid-state electronic image sensor has photoelectric transducers for odd-numbered columns placed in odd-numbered rows and photoelectric transducers for even-numbered columns placed in even-numbered rows, or has photoelectric transducers for odd-numbered columns placed in even-numbered rows and photoelectric transducers for even-numbered columns placed in odd-numbered rows. In a honeycomb-type solid-state electronic image sensor of this kind, image data that has been output from the solid-state electronic image sensor is interpolated to thereby obtain image data representing a high-resolution image in which the number of pixels has essentially been increased.

Since the honeycomb-type solid-state electronic image sensor is different from the conventional solid-state electronic image sensor, there are instances where the characteristics of the honeycomb-type solid-state electronic image sensor must be taken into consideration when image data that has been obtained by sensing the image of a subject is reproduced.

### DISCLOSURE OF THE INVENTION

An object of the present invention is to so arrange it that the characteristics of a honeycomb-type solid-state electronic image sensor can be taken into consideration when image data is reproduced.

According to the present invention, the foregoing object is attained by providing an image sensing apparatus comprising: an image sensing unit, which includes a honeycomb-type solid-state electronic image sensor, for sensing the image of a subject to thereby output image data representing the image of the subject, the honeycomb-type solid-state electronic image sensor having a number of photoelectric transducers disposed in column and row directions, wherein the photoelectric transducers for odd-numbered columns are placed in odd- or even-numbered rows and the photoelectric transducers for even-numbered columns are placed in even- or odd-numbered rows; a first recording controller for recording image data, which is output from the image sensing unit, on a recording medium; and a second recording controller for recording data, which represents characteristics specific to the honeycomb-type solid-state electronic image sensor, on the recording medium in association with the image data.

The present invention provides also an operation control method suited to the above-described apparatus. Specifically, the present invention provides a method of controlling operation of an image sensing apparatus comprising the steps of: sensing the image of a subject and obtaining image data representing the image of the subject using a honeycomb-type solid-state electronic image sensor having a number of photoelectric transducers disposed in column and row directions, wherein the photoelectric transducers for odd-numbered columns are placed in odd- or even-numbered rows and the photoelectric transducers for even-numbered columns are placed in even- or odd-numbered rows; recording the obtained image data on a recording medium; and recording data, which represents characteristics specific to the honeycomb-type solid-state electronic image sensor, on the recording medium in association with the image data.

In accordance with the present invention, the image of a subject is sensed using a honeycomb-type solid-state electronic image sensor, whereby image data representing the image of the subject is obtained. The image data thus obtained is recorded on a recording medium. Furthermore, data representing characteristics specific to the honeycomb-type solid-state electronic image sensor is recorded on the above-mentioned recording medium (preferably a portable recording medium) in association with the image data.

When the image data is reproduced, the above-mentioned image data, as well as data representing the characteristics specific to the honeycomb-type solid-state electronic image sensor that was used to obtain this image data, is obtained from the recording medium. Signal processing (inclusive of correction processing) that is suited to the image data can be executed utilizing the data representing the specific characteristics.

The characteristics specific to the honeycomb-type solid-state electronic image sensor include characteristics based upon the physical structure of the solid-state electronic image sensor, such as the pixel array, the pixel pitch, the angle between mutually adjacent pixels and the shape of the photoreceptor area; characteristics based upon the structure of lenses and the like that belong to the solid-state electronic image sensor, such as the on-chip-lens curvature, index of refraction and position, inner-lens curvature, index of refraction and position, and aberration such as distortion and chromatic aberration of magnification; and other circuit characteristics based upon use of a honeycomb-type solid-state electronic image sensor, such as the characteristic of an optical low-pass filter.

The apparatus may further comprise a storage device for storing data representing the specific characteristics. In such case data representing specific characteristics read out of the storage device would be recorded on the recording medium by the second recording controller.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram illustrating part of the photoreceptor surface of a honeycomb CCD;

FIG. 2 is a diagram illustrating pixels represented by image data obtained by the honeycomb CCD and pixels that have been obtained by interpolation;

FIG. 3 is a block diagram illustrating the electrical construction of a digital still camera;

FIG. 4 illustrates content that has been stored in a ROM; and

FIG. 5 illustrates the structure of a storage area of a memory card.

### DESCRIPTION OF THE PREFERRED EMBODIMENT

A preferred embodiment of the present invention will be described with reference to the drawings.

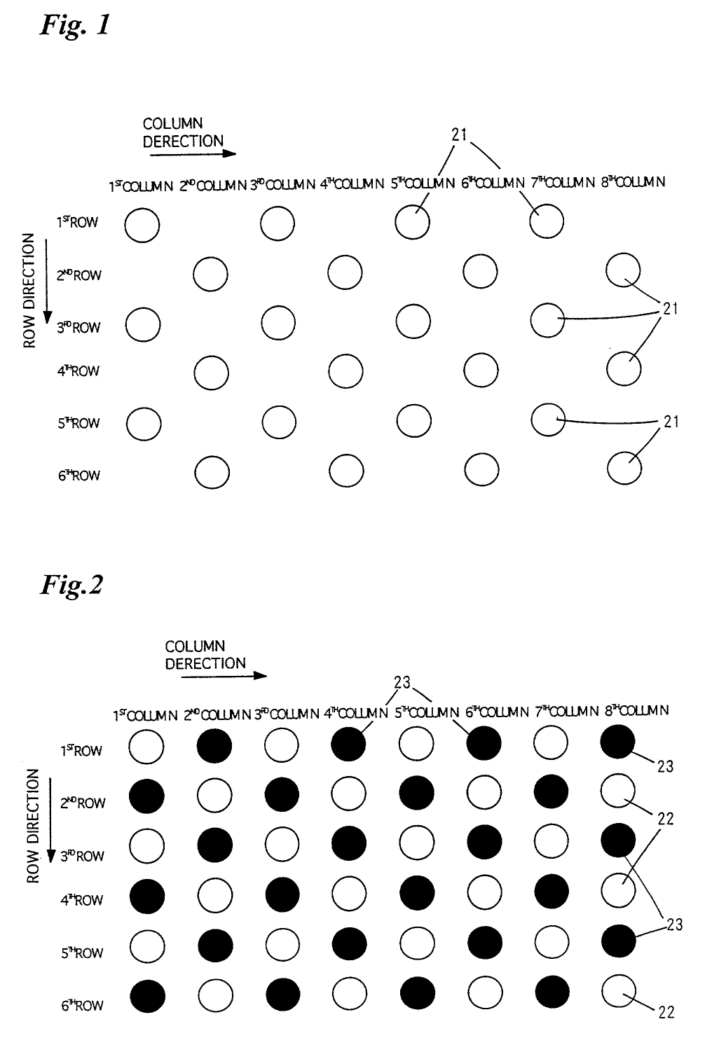

FIG. 1 schematically illustrates part of the photoreceptor surface of a honeycomb CCD.

The honeycomb CCD has a number of photoelectric transducers 21 arrayed in row and column directions. The photoelectric transducers 21 for odd-numbered columns are placed in odd-numbered rows and the photoelectric transducers 21 for even-numbered columns are placed in even-numbered rows. Accordingly, photoelectric transducers 21 for odd-numbered rows are not placed in even-numbered rows and photoelectric transducers 21 for even-numbered rows are not placed in odd-numbered rows. Of course, photoelectric transducers 21 for odd-numbered columns may be placed in even-numbered rows and the photoelectric transducers 21 for even-numbered columns may be placed in odd-numbered rows.

Each photoelectric transducer 21 is provided with an inner lens, a color filter and an on-chip lens (none of which are shown).

By sensing the image of a subject, signal charge accumulates in the photoelectric transducers 21 and image data representing the image of the subject is output from the honeycomb CCD.

FIG. 2 illustrates part of an image.

Pixels 22 are obtained based upon signal charge that has accumulated in the photoelectric transducers 21 that exist in the honeycomb CCD. Pixels at positions where the photoelectric transducers 21 do not exist are interpolated using the pixels 22. Interpolated pixels 23 are produced between the pixels 22 by interpolation processing. Since the number of pixels is thus essentially increased by interpolation processing, an image having a high resolution is obtained.

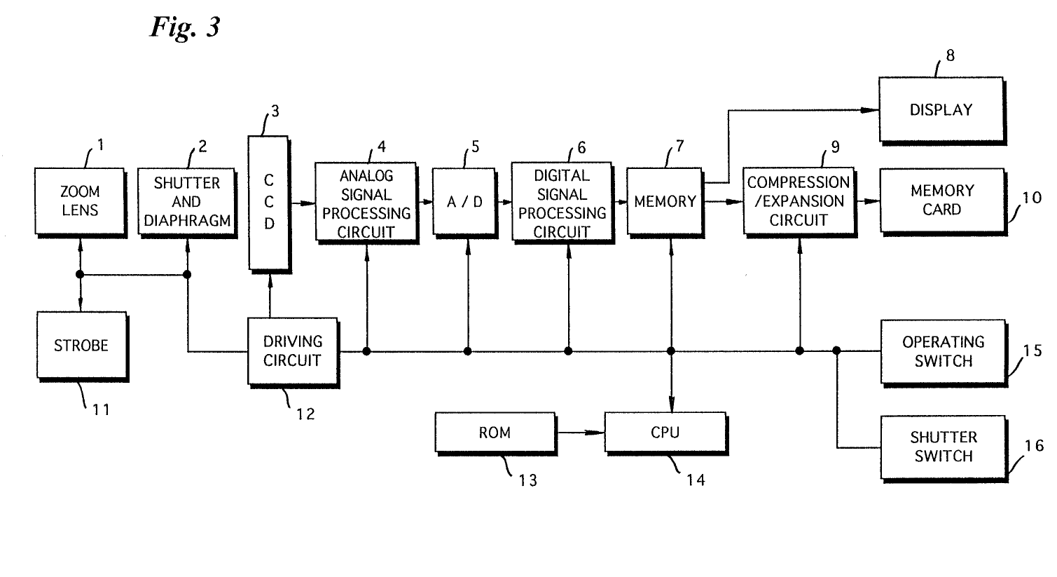

FIG. 3 is a block diagram illustrating the electrical structure of a digital still camera using a honeycomb CCD.

The overall operation of the digital still camera is controlled by a CPU 14.

The CPU 14 is externally provided with a ROM 13 in which data representing the characteristics of the honeycomb CCD 3 has been stored, as will be described later. Image data that has been obtained by sensing the image of a subject is stored on a memory card 10 together with the data representing the characteristics of the honeycomb CCD 3, as will be described later.

The digital still camera includes a shutter switch 16. A signal indicating that the shutter switch 16 has been pressed is input to the CPU 14.

The digital still camera further includes an operating switch 15 for setting various modes such as a picture-taking mode, a strobe picture-taking mode and a playback mode. An output signal from the operating switch 15 also is input to the CPU 14.

The digital still camera further includes a driving circuit 12 for applying driving signals to a variety of circuits, and a strobe circuit 11 for picture taking using a strobe electronic flash.

The image of a subject is focused on the photoreceptor surface of the honeycomb CCD 3 by a zoom lens 1 via a shutter and diaphragm 2. The honeycomb CCD 3 senses the image of the subject and outputs a video signal representing the sensed image. The video signal output from the honeycomb CCD 3 is input to an analog signal processing circuit 4, which subjects the video signal to analog signal processing such as a color balance adjustment and gamma correction.

The video signal output from the analog signal processing circuit 4 is converted to digital image data by an analog-to-digital conversion circuit 5. The digital image data obtained by the conversion is input to a digital signal processing circuit 6, which executes the interpolation processing mentioned earlier. The interpolated image data is applied to a display unit 8 via a memory 7, whereby the image of the subject obtained by sensing is displayed.

If the shutter switch 16 is pressed, the image data that has been output from the digital signal processing circuit 6 is stored temporarily in the memory 7. The image data is read out of the memory 7 and is compressed in a compression/expansion circuit 9. The compressed image data is applied to the memory card 10, where the data is recorded.

Further, data representing the characteristics specific to the honeycomb CCD 3 is read out of the ROM 13 and is stored temporarily in the memory 7. The characteristics data is read out of the memory 7, applied to the memory card 10 via the compression/expansion circuit 9 and recorded on the card 10 in association with the image data.

If the playback mode is set by the operating switch 15, the compressed image data that has been stored on the memory card 10 is read out and applied to the compression/expansion circuit 9. The latter expands the image data and applies the expanded image data to the display unit 8 via the memory 7.

Thus, an image represented by image data that has been recorded on the memory card 10 is displayed on the display screen of the display unit 8.

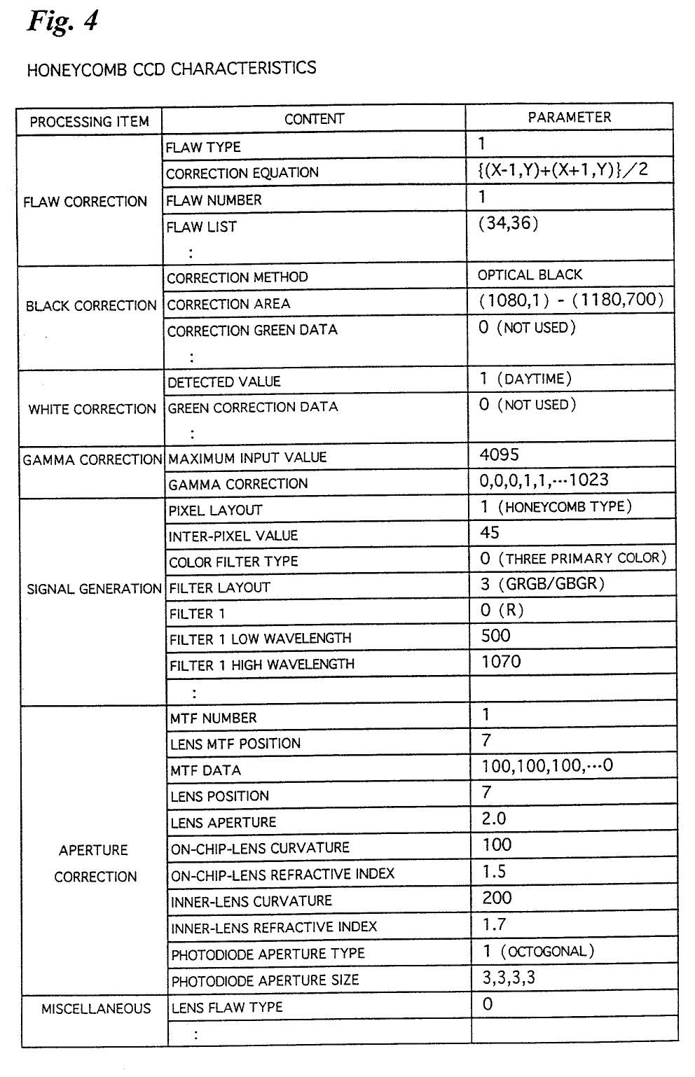

FIG. 4 illustrates an example of data, which represents characteristics specific to a honeycomb CCD, stored in the ROM 13.

In this embodiment, the characteristics specific to the honeycomb CCD are stored in association with processing items indicating which signal processing is used.

Examples of the processing items are as follows:

Flaw correction:

This is a correction for flaws possessed by the honeycomb CCD 3 itself. Flaw corrections include flaw type (a white flaw wherein an output is obtained even though a pixel should be dark; a black flaw wherein an output is not obtained even though a pixel should be bright; a modulation flaw wherein a signal output fluctuates, etc.); a correction equation for when a flaw is corrected; a flaw number indicating the content of a flaw; and a flow list, etc.

Black correction:

This is a correction for when a signal obtained from a photoelectric transducer that is to output a signal is recorded. Items include correction method, correction area, etc.

White correction:

This is referred to as a white balance adjustment. Items include detected values, etc., used in the white balance adjustment.

Gamma correction:

Items include maximum input value and a gamma table.

Signal generation:

This is used in the generation of a luminance signal and color difference signals. Items include pixel layout; angle between pixels; type of color filter provided on the photoelectric transducers 21 of the honeycomb CCD 3; filter layout, etc.

Aperture correction:

This is for calculating the MTF (Modulation Transfer Function). Items include MTF number; lens MTF position; MTF data; lens position; lens aperture; on-chip-lens curvature; on-chip-lens refractive index; inner-lens curvature; inner-lens refractive index; photodiode (photoelectric transducer) aperture type; photodiode aperture size, etc.

Miscellaneous:

This includes type of lens flaw.

These items of characteristics data are recorded on the memory card 10 in association with the image data.

An arrangement may of course be adopted in which, in addition to the characteristics data mentioned above, aberration of the zoom lens 1, such as distortion and chromatic aberration of magnification, and the characteristics of an optical low-pass filter when such a filter is used are recorded on the memory card 10 in association with image data.

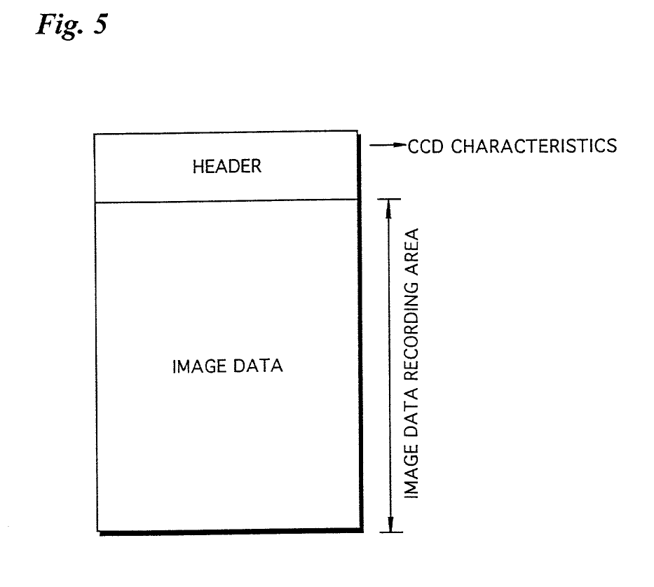

FIG. 5 illustrates the structure of the recording area of the memory card 10.

As shown in FIG. 5, the memory card 10 includes a header and an image data recording area.

Image data representing the image of a subject obtained by sensing is recorded in the image data recording area.

Data representing characteristics specific to the honeycomb CCD 3 is recorded in the header, in the manner described earlier, in addition to the path to the image data that has been recorded in the image data recording area. It goes without saying that correspondence is established between the image data representing the characteristics specific to the honeycomb CCD 3 and the image data that has been stored in the image data recording area.

Since data representing the characteristics specific to the honeycomb CCD 3 is stored in the header of the memory card 10 in association with image data, signal processing such as correction of the image data can be performed comparatively accurately using the specific characteristics at the time of image-data playback.

More specifically, the memory card 10 on which the data representing characteristics specific to the honeycomb CCD 3 is loaded in a personal computer. The image data and the data representing the specific characteristics is read by the personal computer. The image data that has been read is processed using the data representing the specific characteristics.

As many apparently widely different embodiments of the present invention can be made without departing from the spirit and scope thereof, it is to be understood that the invention is not limited to the specific embodiments thereof except as defined in the appended claims.

What is claimed is:

1. An image sensing apparatus comprising:
an image sensing unit, which includes a honeycomb-type solid-state electronic image sensor, for sensing the image of a subject to thereby output image data representing the image of the subject, said honeycomb-type solid-state electronic image sensor having a number of photoelectric transducers disposed in column and row directions, wherein the photoelectric transducers for odd-numbered columns are placed in odd- or even-numbered rows and the photoelectric transducers for even-numbered columns are placed in even- or odd-numbered rows;
a first recording controller for recording image data, which is output from said image sensing unit, on a recording medium; and
a second recording controller for recording data, which represents characteristics specific to the honeycomb-type solid-state electronic image sensor, on the recording medium in association with the image data.

2. The apparatus according to claim 1, further comprising a storage device for storing the data representing the specific characteristics;
wherein said second recording controller records the data representing the specific characteristics on the storage medium, said data being read out of said storage device.

3. A method of controlling operation of an image sensing apparatus, comprising the steps of:
sensing the image of a subject and obtaining image data representing the image of the subject using a honeycomb-type solid-state electronic image sensor having a number of photoelectric transducers disposed in column and row directions, wherein the photoelectric transducers for odd-numbered columns are placed in odd- or even-numbered rows and the photoelectric transducers for even-numbered columns are placed in even- or odd-numbered rows;
recording the obtained image data on a recording medium; and
recording data, which represents characteristics specific to the honeycomb-type solid-state electronic image sensor, on the recording medium in association with the image data.
